(19) United States
(12) Patent Application Publication
(10) Pub. No.: US 2007/0115779 A1
(43) Pub. Date: May 24, 2007

(54) Optical disk recording and reproducing device

(75) Inventor: Yoshikazu Fujita, Osaka (JP)

Correspondence Address: MORGAN LEWIS & BOCKIUS LLP, 1111 PENNSYLVANIA AVENUE NW, WASHINGTON, DC, 20004, US

(73) Assignee: Funai Electric Co., Ltd.

(21) Appl. No.: 11/600,083

(22) Filed: Nov. 16, 2006

(30) Foreign Application Priority Data
Nov. 24, 2005 (JP) 2005-338634

(51) Int. Cl. G11B 7/00

(52) U.S. Cl. 369/53.2

(57) ABSTRACT

It is supposed that recording of a drama program is started in accordance with recording reservation, and the recording is finished. If a program to be recorded next is a sports program, a message “Exchange the loaded disk with an optical disk for recording sports programs” is displayed on the display portion. When viewing this display, the user takes out the loaded optical disk for recording drama programs and loads an optical disk for recording sports programs to the device. When the recording of the sports program is finished and if a program to be recorded next is a language education program, a message “Exchange the loaded disk with an optical disk for recording language education programs” is displayed on the display portion. When viewing this display, the user takes out the loaded optical disk for recording sports programs and loads an optical disk for recording language education programs to the device.

This application is based on Japanese Patent Application No. 2005-338634 filed on Nov. 24, 2005, the contents of which are hereby incorporated by reference.

### BACKGROUND OF THE INVENTION

1. Field of the Invention

The present invention relates to an optical disk recording and reproducing device for recording and reproducing information on an optical disk. In particular, the present invention relates to an optical disk recording and reproducing device having a function of designating an optical disk that is classified in accordance with a title or a genre of a program when recording of a television program is reserved.

2. Description of Related Art

Recently, a digital versatile disk (DVD) that is an optical disk capable of recording a large quantity of video and audio data such as a movie has become commonplace. There are several types of the DVD includes a DVD-ROM that stores information recorded on a manufacture's side and cannot be rewritten on a user's side, a DVD-R and a DVD+R on which information can be written only once on the user's side, and a DVD-RW, a DVD+RW and a DVD-RAM on which information can be rewritten a predetermined number of times on the user's side. Information recorded on the DVD can be reproduced by using an optical disk reproducing device (i.e., a DVD player) or an optical disk recording and reproducing device (i.e., a DVD recorder), and information can be recorded on the DVD-R, the DVD+R, the DVD-RW, the DVD+RW or the DVD-RAM by using the optical disk recording and reproducing device.

When recording of a television program (i.e., recording of pictures and sounds) is performed, a rewritable optical disk, i.e., the DVD-RW, the DVD+RW or the DVD-RAM may be used in many cases. If a user wants to do a recording reservation of a television program in advance for recording a television program in the rewritable optical disk, the user may use a recording reservation function that is usually equipped to a conventional optical disk recording and reproducing device.

When the user use the recording reservation function for making the recording reservation of a television program, the user may operate a remote controller so that a display device displays an electronic program guide (EPG). Then, the user may select a television program that is a target of the recording reservation from the electronic program guide and do a determining operation for completing the recording reservation of the television program. Alternatively, the user may; utilize a G-code displayed as detailed contents of the electronic program guide or a G-code included in a program guide on a newspaper or the like for making the recording reservation.

When using the conventional optical disk recording and reproducing device having the recording reservation function, it may be desired to record television programs by recording reservation on different optical disks for different contents (titles or genres). For example, if the user intends to make the recording reservation of a sports program, the user may load the optical disk recording and reproducing device with an optical disk for recording only sports programs for making the recording reservation of the sports program.

If a plurality of recording reservations of different television programs are made in the conventional optical disk recording and reproducing device, e.g., recording reservations of a drama program, a sports program and a language education program are made in this order of recording date and time, the user may set an optical disk for recording drama programs before the recording of the drama program is started. When, the recording of the drama program is finished, the user may check the television program that will be recorded next by operating the remote controller so that a recording reservation table is displayed on the display device or by looking up a memo if the user has made the memo of the recording reservations. Then, the user may exchange the set optical disk with another optical disk for recording sports programs before the recording of the sports program is started.

However, if the user fails to check the television program that will be recorded next (the sports program in this case) and exchange the optical disk, the sports program will be recorded on the optical disk for recording drama programs, which is an undesired result for the user. This result is caused from a mistake of the user who has failed to manage the program contents of the recording reservations and optical disks to be used. To put it briefly, the conventional optical disk recording and reproducing device has a disadvantage of poor usability in that the user has to manage the program contents of the recording reservations and optical disks to be used since the user has to check the television program that will be recorded next if the user want to use different optical disks for recording different program contents.

JP-A-2002-369111 discloses a technique of recording programs of the same type on a specific disk by using recording reservation information about recording reservations of broadcast programs. The recording reservation information is recorded on the disk (optical disk) in advance. If the program that will be recorded next is the same type as the preceding program of the recording reservation, this conventional technique will work without a problem. However, if they are different types, the user may still have to operate the remote controller so that the recording reservation table is displayed on the display device or check the memo of the recording reservation if the user has made the memo for checking the program that will be recorded next. Therefore, there is still a problem that the user has to manage the program contents of the recording reservations and optical disks to be used resulting in a poor usability.

### SUMMARY OF THE INVENTION

An object of the present invention is to provide an optical disk recording and reproducing device having a function of displaying a guidance for the user to load or exchange a suitable optical disk when the user wants to use different optical disks for different program contents.

The optical disk recording and reproducing device of the present invention is equipped with a system controller that includes a disk discriminating information storing portion for storing a disk discriminating information table in a memory, for discriminating the optical disk in accordance with a type of a television program when the optical disk is loaded; a recording reservation information storing portion for storing recording reservation information table in a memory, which was set when the recording reservation was made; a program disk discriminating information recording portion for assigning program discriminating information and disk identification information to an unused optical disk when it is loaded and for recording the information on the optical disk; a memory side information obtaining portion for obtaining the program discriminating information of next recording from the recording reservation information table stored in the memory and the disk identification information from the disk discriminating information table stored in the memory when the recording reservation of the television program is made or the recording is finished; an optical disk side information obtaining portion for obtaining the program discriminating information and the disk identification information recorded on an optical disk when the optical disk is loaded after the program discriminating information and the disk identification information are obtained; a suitable optical disk load instruction display portion for making the display portion display a message for instructing the user to load a suitable optical disk indicated by the program discriminating information and the disk identification information and for making the display portion display program discriminating information of the next recording if an optical disk is not loaded after the memory side information obtaining portion obtained the program discriminating information and the disk identification information and a suitable optical disk exchange instruction display portion for making the display portion display a message for instructing the user to exchange the loaded disk with an optical disk that is suitable for a program discrimination number and the disk identification information of the memory side and for making the display portion display program discriminating information of the next recording if the program discriminating information and the disk identification information obtained by the memory side information obtaining portion do not match with the program discriminating information and the disk identification information obtained by the optical disk side information obtaining portion after the optical disk side information obtaining portion obtained the program discriminating information and the disk identification information.

In this structure, the recording reservation information storing portion stores the recording reservation information table in the memory. The recording reservation information table was set when the recording reservation was made. The disk discriminating information storing portion stores the disk discriminating information table in the memory for discriminating the optical disk in accordance with a type of the program if the optical disk is loaded when the recording reservation is made. In addition, if an unused optical disk is loaded when the recording reservation is made, the program disk discriminating information recording portion assigns the program discriminating information and the disk identification information to the optical disk and records the information on the optical disk.

When the recording reservation is made in this way, or when the recording is finished, the memory side information obtaining portion obtains the program discriminating information of the next recording from the recording reservation information table stored in the memory and the disk identification information from the disk discriminating information table stored in the memory. If the optical disk is loaded, the optical disk side information obtaining portion obtains the program discriminating information and the disk identification information recorded on the loaded optical disk. On the other hand, if the optical disk is not loaded, the suitable optical disk load instruction display portion makes the display portion display a message for instructing the user to load a suitable optical disk indicated by the program discriminating information and the disk identification information. It also makes the display portion display the program discriminating information of the next recording.

After the optical disk side information obtaining portion obtained the program discriminating information and the disk identification information, if the program discriminating information and the disk identification information obtained by the memory side information obtaining portion do not match with the program discriminating information and the disk identification information obtained by the optical disk side information obtaining portion, the suitable optical disk exchange instruction display portion makes the display portion display a message for instructing the user to exchange the loaded disk with an optical disk suitable for the program discrimination number and the disk identification information of the memory side. It also makes the display portion display the program discriminating information of the next recording.

According to this structure, when the user wants to use different optical disks for recording different television programs in accordance with their contents, it is possible to make a display for instructing the user to load a suitable optical disk or exchange the optical disk. Thus, the user can avoid loading an unsuitable optical disk or failure in exchanging the loaded disk with a suitable one. In addition, after the recording reservation is made, if the optical disk is not loaded, a display is made for instructing the user to load a suitable optical disk. Therefore, it is prevented to load an unsuitable optical disk. In addition, after the recording of the previous recording reservation is finished and before the next recording is started, if the type of the next program is different from that of the previous program, a display is made for instructing the user to exchange the loaded disk with a suitable optical disk. Therefore, it is prevented to record on the unsuitable optical disk. Furthermore, since the program discriminating information of the program to be recorded next is displayed, the user does not need to look up the next program. By using the optical disk recording and reproducing device having this structure, it is possible to reduce the user's load of managing the program contents of the recording reservations and the optical disks to be used, resulting in an improvement of usability.

In a preferred embodiment, the disk discriminating information table includes program discriminating information indicating a title, a genre and a serial number of the same title for discriminating the television program to be recorded on the optical disk, disk identification information for identifying the optical disk and remaining time information indicating remaining time for which the recording can be performed on the optical disk. Therefore, a display for instructing the user to load a suitable optical disk, a display for instructing the user to exchange the loaded disk with a suitable one, and a display for instructing the user to exchange the loaded disk with an unused optical disk can be performed appropriately.

In another preferred embodiment, the recording reservation information table includes a channel that was set when the recording reservation was made, a recording date and time, recording hours and program discriminating information. Therefore, a display for instructing the user to load a suitable optical disk, a display for instructing the user to exchange the loaded disk with a suitable one, and a display for instructing the user to exchange the loaded disk with an unused optical disk can be performed appropriately.

In still another preferred embodiment, the system controller includes an unused optical disk exchange instruction display portion for makes the display portion display a message for instructing the user to exchange the loaded disk with an unused optical disk if remaining time for which the recording can be performed on the optical disk is shorter than recording hours of the program although the program discriminating information and the disk identification information obtained by the memory side information obtaining portion match with the program discriminating information and the disk identification information obtained by the optical disk side information obtaining portion. According to this structure, if remaining time for which the recording can be performed on the optical disk is shorter than the recording hours of the program, a message for instructing the user to exchange the loaded disk with an unused optical disk can be displayed on the display portion.

As described above, according to the present invention, if the user wants to use different optical disks for different television programs in accordance with the program contents, a display for instructing the user to load a suitable optical disk or to exchange the optical disk can be performed, thereby it is prevented to load an unsuitable optical disk or to fail in exchanging the loaded disk with a suitable optical disk.

In addition, after the recording reservation was performed, if no optical disk is loaded, a display for instructing the user to load a suitable optical disk is performed. Therefore, it is prevented to load an unsuitable optical disk. In addition, after the recording of the previous recording reservation is finished and before the next recording is started, if the program contents is different from that of the previous one, a display for instructing the user to exchange the loaded disk with a suitable one. Therefore, it is prevented to record on an unsuitable optical disk. In addition, since the program discriminating information of the program to be recorded next is displayed, the user does not need to look up the next program. By using the optical disk recording and reproducing device having this structure, it is possible to reduce the user's load of managing the program contents of the recording reservations and the optical disks to be used, resulting in an improvement of usability.

### BRIEF DESCRIPTION OF THE DRAWINGS

FIG. 1 is a block diagram showing a structure of an optical disk recording and reproducing device according to an embodiment of the present invention.

FIG. 2 is a diagram of a recording reservation information table showing an example of contents of recording reservation information in the embodiment.

FIG. 3 is a diagram of a disk discriminating information table showing an example of contents of disk discriminating information in the embodiment.

FIG. 4 is a diagram for explaining an example of contents of a recording reservation and timing and contents of a message for instructing an exchange of the loaded optical disk with a suitable one.

FIG. 5 is a flowchart for explaining a process for instructing the user to select an optical disk suitable for a type of the program and to load the disk when the program is recorded on the optical disk in the embodiment.

### DESCRIPTION OF THE PREFERRED EMBODIMENTS

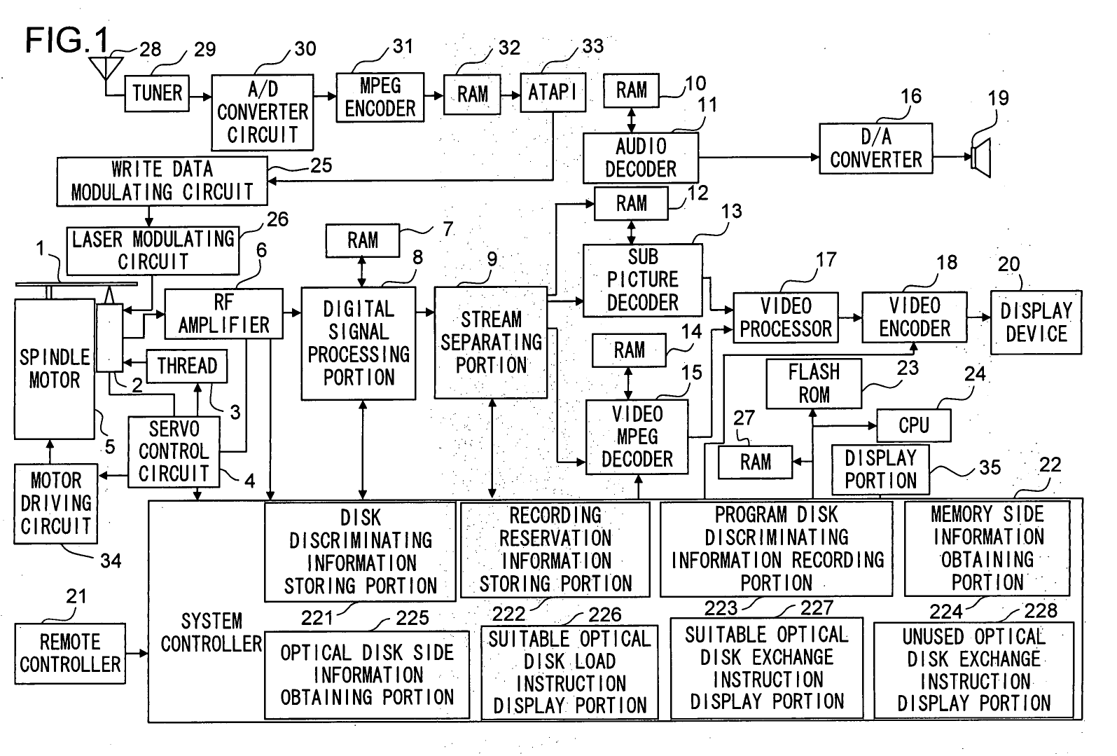

Now, an embodiment of the present invention will be described with reference to the attached drawings. FIG. 1 is a block diagram showing a structure of an optical disk recording and reproducing device according to an embodiment of the present invention.

This optical disk recording and reproducing device is equipped with a system controller 22 for controlling a whole device, a spindle motor 5 for rotating an optical disk 1, an optical pickup 2 for writing and reading information on the optical disk 1 optically, a thread 3 for moving the optical pickup 2 in the radial direction of the optical disk 1, and a servo control circuit 4 for driving the spindle motor 5 and the thread 3 via a motor driving circuit 34 and moving an objective lens (not shown) embedded in the optical pickup 2 so that a focus position of a laser beam is moved with respect to a recording surface of the optical disk 1 in the vertical direction and in the horizontal direction in accordance with an instruction from the system controller 22.

In addition, this optical disk recording and reproducing device is equipped with an RF amplifier 6 for amplifying an RF signal that is a read signal from the optical pickup 2 when the optical disk 1 is read, a digital signal processing portion 8 for converting the RF signal outputted from the RF amplifier 6 into digital data and for performing a signal modulating process and an error correcting process in accordance with a data format of the optical disk 1 so that the generated data is stored in a RAM 7 as a buffer memory, and a stream separating portion 9 for separating audio data, sub picture data and video data from a data stream outputted from the digital signal processing portion 8 in accordance with an instruction of the system controller 22.

In addition, this optical disk recording and reproducing device is equipped with an audio decoder 11 for performing a predetermined decode process after receiving the audio data outputted from the stream separating portion 9, a RAM 10 for storing data temporarily for the audio decoder 11 to perform the decode process, a sub picture decoder 13 for performing a predetermined decode process after receiving the sub picture data outputted from the stream separating portion 9, a RAM 12 for storing data temporarily for the sub picture decoder 13 to perform the decode process, a video MPEG decoder 15 for performing a MPEG decode process after receiving the video data outputted from the stream separating portion 9, and a RAM 14 for storing data temporarily for the video MPEG decoder 15 to perform the decode process.

In addition, this optical disk recording and reproducing device is equipped with a video processor 17 for combining data outputted from the video decoder 15 and data outputted by the sub picture decoder 13 in accordance with an instruction from the system controller 22, a video encoder 18 for converting the composite data outputted from the video processor 17 into a video signal for display so that a display device 20 displays images, and a D/A converter 16 for converting the data outputted from the audio decoder 11 into an analog audio signal so as to supply the signal to a speaker 19 for example via an audio circuit (not shown).

In addition, this optical disk recording and reproducing device is equipped with a remote controller 21 including a record key for giving a record instruction to the system controller 22, a play key for giving a play instruction, a stop key for instructing a stop of recording or reproduction, and other various operational keys, a main body console portion (not shown) having less operational keys than the remote controller 21, and a display portion 35 for display operational contents and modes instructed by the remote controller 21 or the main body console portion. Furthermore, this optical disk recording and reproducing device is equipped with a flash ROM 23 as a nonvolatile memory storing programs and data for controlling each structural element of the device and controlling the whole device, a CPU 24 for performing operational processes so as to control the system controller 22 in accordance with the programs and data stored in the flash ROM 23, and a RAM 27 for storing data temporarily that are necessary for the CPU 24 to perform the operational processes.

In addition, this optical disk recording and reproducing device is equipped with a tuner 29 that is connected to an antenna 28, an A/D converter circuit 30 for converting analog video and audio signals of the television program selected by the tuner 29 or video and audio signals from a television receiver or other video and audio output devices (not shown) into digital video and audio data, a MPEG encoder 31 for encoding the video and audio data by MPEG, a RAM 32 as a buffer memory for storing temporarily a predetermined quantity of the encoded video and audio data (hereinafter referred to as encoded data), an ATAPI (AT Attachment Packet Interface) 33 that is an interface for connecting to a write data modulating circuit 25, the write data modulating circuit 25 for modulating the encoded data from the ATAPI 33 so as to record the data on the optical disk 1, a laser modulating circuit 26 for supplying the optical pickup 2 with a laser modulating signal in accordance with the modulated data modulated by the write data modulating circuit 25 so as to modulating a laser beam that is emitted from the optical pickup 2.

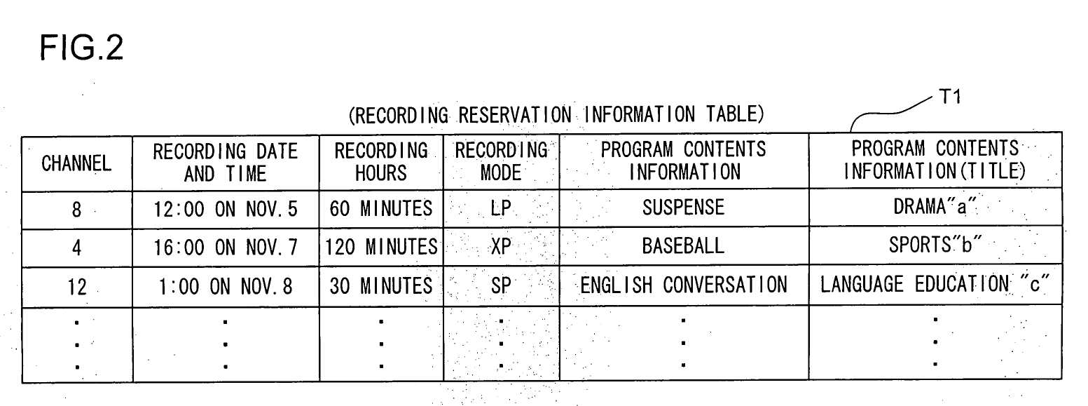

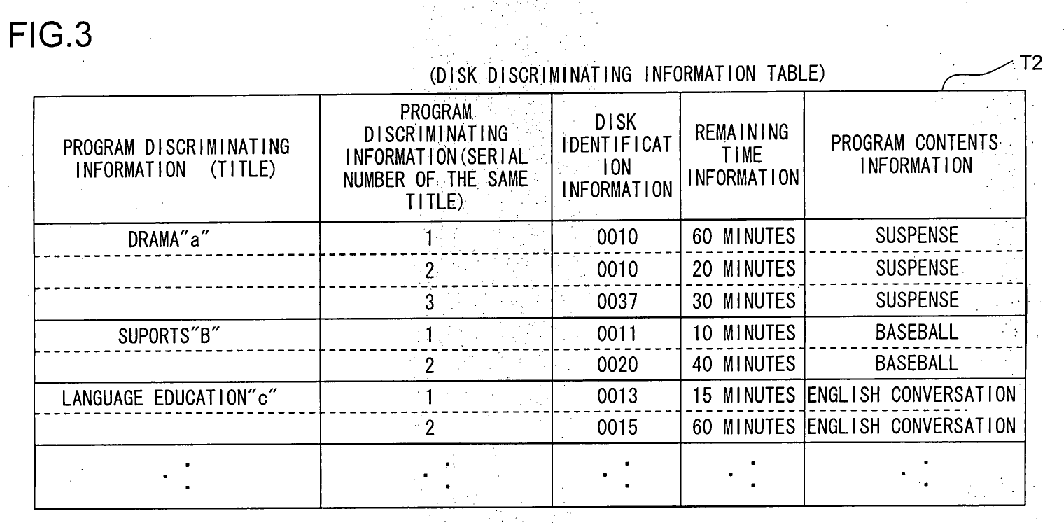

The system controller 22 is equipped with structural elements unique to the present embodiment, which include a disk discriminating information storing portion 221, a recording reservation information storing portion 222 and a program disk discriminating information recording portion 223. The disk discriminating information storing portion 221 stores a disk discriminating information table T2 (see FIG. 3) in the flash ROM 23. The disk discriminating information table T2 includes program discriminating information, disk identification information and remaining time information, for discriminating the an optical disk in accordance with a type of the television program when the optical disk is loaded. The program discriminating information indicates a title, a genre and a serial number of the same title for discriminating the television program to be recorded on the optical disk. The disk identification information is used for identifying the optical disk. The remaining time information indicates remaining time for which the recording can be performed on the optical disk. The recording reservation information storing portion 222 stores a recording reservation information table T1 (see FIG. 2) in the flash ROM 23. The recording reservation information table T1 includes a channel that was set when the recording reservation was made, a recording date and time, recording hours and program discriminating information. The program disk discriminating information recording portion 223 assigns the program discriminating information and the disk identification information to an unused optical disk and records the information on the optical disk when the optical disk is loaded.

In addition, the system controller 22 is equipped with a memory side information obtaining portion 224, an optical disk side information obtaining portion 225 and a suitable optical disk load instruction display portion 226. The memory side information obtaining portion 224 obtains the program discriminating information of next recording from the recording reservation information table T1 stored in the flash ROM 23 and the disk identification information from the disk discriminating information table T1 stored in the flash ROM 23 when the recording reservation of the television program is made or the recording is finished. The optical disk side information obtaining portion 225 obtains the program discriminating information and the disk identification information recorded on an optical disk when the optical disk is loaded after the program discriminating information and the disk identification information are obtained. The suitable optical disk load instruction display portion 226 displays on the display device 20 and/or the display portion 35 a message for instructing the user to load a suitable optical disk indicated by the program discriminating information and the disk identification information and for displaying program discriminating information of the next recording on the display device 20 and/or the display portion 35 if an optical disk is not loaded after the memory side information obtaining portion 224 obtained the program discriminating information and the disk identification information.

In addition, the system controller 22 is equipped with a suitable optical disk exchange instruction display portion 227 and an unused optical disk exchange instruction display portion 228. The suitable optical disk exchange instruction display portion 227 displays on the display device 20 and/or the display portion 35 a message for instructing the user to exchange the loaded disk with an optical disk that is suitable for a program discrimination number and the disk identification information of the memory side and for displaying program discriminating information of the next recording on the display device 20 and/or the display portion 35 if the program discriminating information and the disk identification information obtained by the memory side information obtaining portion 224 do not match with the program discriminating information and the disk identification information obtained by the optical disk side information obtaining portion 225 after the optical disk side information obtaining portion 225 obtained the program discriminating information and the disk identification information. The unused optical disk exchange instruction display portion 228 displays a message on the display device 20 and/or the display portion 35 for instructing the user to exchange the loaded disk with an unused optical disk if remaining time for which the recording can be performed on the optical disk is shorter than the recording hours of the program although the program discriminating information and the disk identification information obtained by the memory side information obtaining portion 224 match with the program discriminating information and the disk identification information obtained by the optical disk side information obtaining portion 225.

FIG. 2 is a diagram of a recording reservation information table showing an example of contents of recording reservation information in the embodiment.

In this recording reservation information table T1, “channel” means a channel of a television broadcast station. Further, “recording date and time” indicates a date and time when recording of a set recording reservation is started (including a start time and an end time of recording), and “recording hours” indicates a recording time period from the start to the end of recording. Further, “recording mode” indicates image quality of recording, and the recording mode includes XP, SP, LP and EP. The XP has higher image quality than the SP and can record a half time of the SP. The SP is a recording mode having standard image quality. The LP has lower image quality than the SP but can record twice time of the SP. The EP has lower image quality than the LP but can record triple time of the SP. Further, “program contents information” indicates a description of contents of a program title or the like, and “program discriminating information” indicates a program title.

In this recording reservation information table T1, as to a recording reservation at 12:00 on November, 5 of the recording date and time, the channel is 8, the recording hours are 60 minutes, the recording mode is LP, the program contents information is a suspense, the program discriminating information (title) is a drama “a”. As to a recording reservation at 16:00 on November, 7 of the recording date and time, the channel is 4, the recording hours are 120 minutes, the recording mode is XP, the program contents information is a baseball, and the program discriminating information (title) is sports “b”. As to a recording reservation at 1:00 on November, 8 of the recording date and time, the channel is 12, the recording hours are 30 minutes, the recording mode is SP, the program contents information is English conversation, the program discriminating information, (title) is a language education “c”.

FIG. 3 is a diagram of a disk discriminating information table showing an example of contents of disk discriminating information in this embodiment.

In this disk discriminating information table T2, “program discriminating information” indicates a title, “serial number of the same title” indicates a serial number of the title having the same program title. Further, “disk identification information” indicates an identification number for identifying the optical disk. Further, “remaining time information” indicates a remaining time for which the recording can be performed on the optical disk. Further, “program contents information” indicates a description of contents of the program title or the like.

In this disk discriminating information table T2, the drama “a” of the program discriminating information (title) has the serial numbers 1, 2 and 3. As to the serial number 1 of the drama “a”, the identification number of the optical-disk is 0010, the remaining time for which the recording can be performed on the optical disk is 60 minutes, and the program contents information is the suspense. As to the serial number 2 of the drama “a”, the identification number of the optical disk is 0010, the remaining time for which the recording can be performed on the optical disk is 20 minutes, and the program contents information is the suspense. As to the serial number 3 of the drama “a”, the identification number of the optical disk is 0037, the remaining time for which the recording can be performed on the optical disk is 30 minutes, and the program contents information is the suspense. Since the remaining time for which the recording can be performed on the optical disk is 60 minutes when the serial number 1 of the drama “a” has been recorded, the serial number 2 of the drama “a” (whose recording hours is 60 minutes) can be recorded on the same optical disk (of the identification number 0010). Therefore, the user may record the serial number 2 of the drama “a” on the optical disk of the identification number 0010, too.

The sports “b” of the program discriminating information (title) has the serial numbers 1 and 2. As to the serial number 1 of the sports “b”, the identification number of the optical disk is 0011, the remaining time for which the recording can be performed on the optical disk is 10 minutes, and the program contents information is the baseball. As to the serial number 2 of the sports “b”, the identification number of the optical disk is 0020, the remaining time for which the recording can be performed on the optical disk is 40 minutes, and the program contents information is the baseball.

The language education “c” of the program discriminating information (title) has the serial numbers 1 and 2. As to the serial number 1 of the language education “c”, the identification number of the optical disk is 0013, the remaining time for which the recording can be performed on the optical disk is 15 minutes, and the program contents information is the English conversation. As to the serial number 2 of the language education “c”, the identification number of the optical disk is 0015, the remaining time for which the recording can be performed on the optical disk is 60 minutes, and the program contents information is the English conversation.

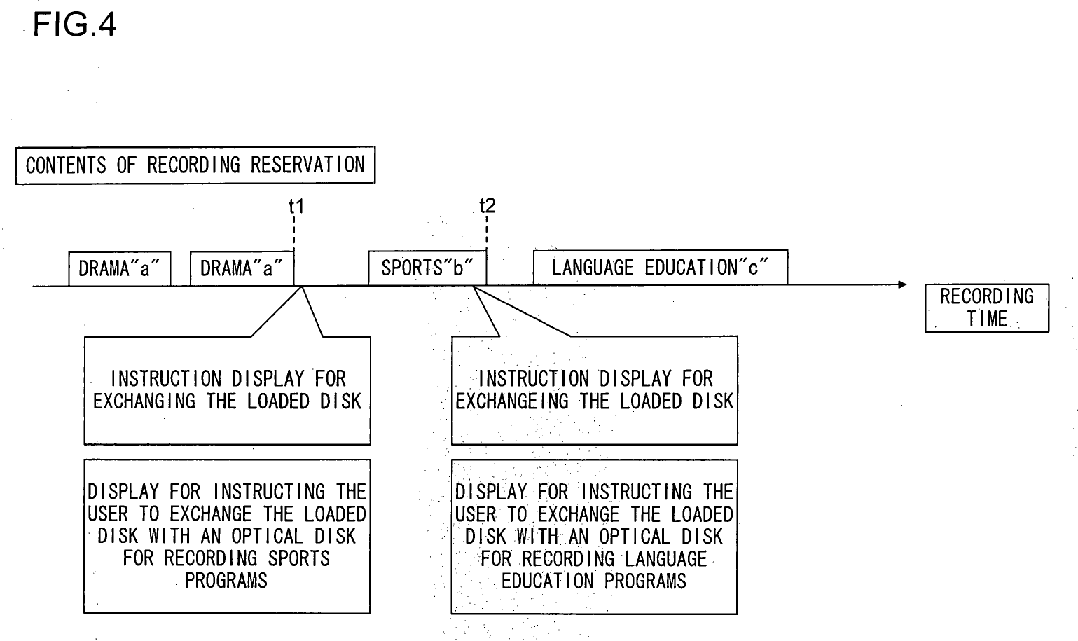

FIG. 4 is a diagram for explaining an example of contents of a recording reservation and a timing and contents of a message for instructing an exchange of the loaded optical disk with a suitable one.

In FIG. 4, it is supposed that the recording of the recording reservation is performed in an order as shown in FIG. 2, for example. The recording of the drama “a” is finished at a time point t1, and the program of the next recording is the sports “b”. Therefore, a message “Exchange the loaded disk with an optical disk for recording sports programs” is displayed on the display device 20 and/or the display portion 35. When the user sees this display, the user may take out the optical disk for recording drama programs from the device and may loads the optical disk for recording sports programs to the device. Afterwards, the recording of the sports “b” is finished at a time point t2, and the program of the next recording is the language education “c”. Therefore, a message “Exchange the loaded disk with an optical disk for recording language education programs” is displayed on the display device 20 and/or the display portion 35. When the user sees this display, the user may take out the optical disk for recording sports programs from the device and loads the optical disk for recording language education programs to the device.

The optical disk for recording drama programs means the optical disk having the disk identification information (disk identification number) of 0010 or 0037 as shown in FIG. 3, for example. The optical disk for recording sports programs means the optical disk having the disk identification information (disk identification number) of 0011 or 0020. The optical disk for recording language education programs means the optical disk having the disk identification information (disk identification number) of 0013 or 0015.

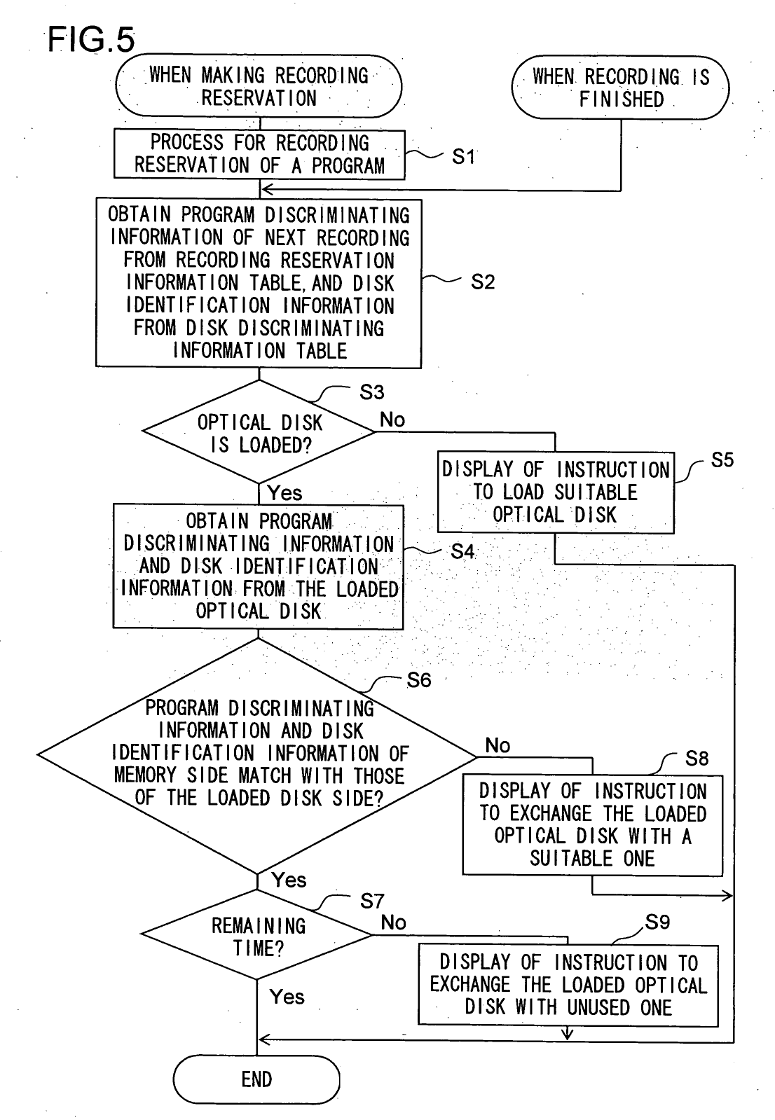

FIG. 5 is a flowchart for explaining a process for instructing the user to select an optical disk suitable for a type of the program and to load the disk when the program is recorded on the optical disk in the embodiment. With reference to this flowchart and FIGS. 1-4, a process for instructing the user to select an optical disk suitable for a type of the program and to load the disk when the program is recorded on the optical disk will be described.

First, the user may operate the remote controller 21 so that the display device 20 displays the electronic program guide, and then the user may select a program as a target of the recording reservation from the electronic program guide. When the program is determined, a process for the recording reservation of the program is performed (Step S1). Alternatively, the user can make the recording reservation by using a G-code displayed on detailed contents of the electronic program guide or a G-code included in a program guide on a newspaper or the like. The recording reservation information storing portion 222 of the system controller 22 makes the flash ROM 23 store the recording reservation information table T1 (see FIG. 2) including the channel, the recording date and time, the recording hours, the recording mode, the program contents information and the program discriminating information that were set when the recording reservation was made.

In addition, the disk discriminating information storing portion 221 of the system controller 22 makes the flash ROM 23 store the disk discriminating information table T2 (see FIG. 3) including the program discriminating information indicating the title and the serial number of the same title for discriminating the program to be recorded on the optical disk, the disk identification information for identifying the optical disk and the remaining time information indicating remaining time for which the recording can be performed on the optical disk and the program contents information indicates a description of contents of a program, so that the optical disk is discriminated in accordance with a type of the program when the optical disk is loaded for the recording reservation. In addition, if an unused optical disk is loaded for the recording reservation, the program disk discriminating information recording portion 223 of the system controller 22 assigns the program discriminating information and the disk identification information to the optical disk and stores information in a management information area of the optical disk.

Thus, when the recording reservation is made or when the recording is finished, the memory side information obtaining portion 224 of the system controller 22 obtains the program discriminating information of the next recording from the recording reservation information table. T1 (see FIG. 2) of the flash ROM 23 and obtains the disk identification information from the disk discriminating information table T2 (see FIG. 3) of the flash ROM 23 (Step S2). The disk identification information corresponds to the program discriminating information of the disk discriminating information table T2, and the program discriminating information corresponds to the program discriminating information of the recording reservation information table T1.

If an optical disk is loaded (Step S3), the optical disk side information obtaining portion 225 of the system controller 22 obtains the program discriminating information and the disk identification information recorded on the loaded optical disk (Step S4). On the other hand, if no optical disk is loaded, the suitable optical disk load instruction display portion 226 of the system controller 22 makes the display device 20 display a message by an OSD process for instructing the user to load a suitable optical disk indicated by the program discriminating information and the disk identification information. It also makes the display device 20 display the program discriminating information of the next recording (the drama “a”, the sports “b”, the language education “c” or the like). It is possible to display the message and the program discriminating information on the display portion 35 instead of the display device 20. Alternatively, it is possible to display the message and the program discriminating information on both the display device 20 and the display portion 35.

After the optical disk side information obtaining portion 225 obtained the program discriminating information and the disk identification information, the program discriminating information and the disk identification information obtained by the memory side information obtaining portion 224 are compared with the program discriminating information and the disk identification information obtained by the optical disk side information obtaining portion 225. If they don't match with each other (Step S6), the suitable optical disk exchange instruction display portion 227 of the system controller 22 makes the display device 20 display a message by the OSD process for instructing the user to exchange the loaded disk with an optical disk that is suitable for a program discrimination number and the disk identification information of the memory side. It also makes the display device 20 display the program discriminating information of the next recording (Step S8).

If the remaining time for which the recording can be performed on the optical disk is shorter than the recording hours of the program although the program discriminating information and the disk identification information obtained by the memory side information obtaining portion 224 match with the program discriminating information and the disk identification information obtained by the optical disk side information obtaining portion 225 (Step S6), the unused optical disk exchange instruction display portion 228 of the system controller 22 makes the display device 20 and/or the display portion 35 display a message by the OSD process for instructing the user to exchange the loaded disk with an unused optical disk (Step S9).

As described above, according to the present embodiment, when the user wants to use different optical disks for recording different television programs in accordance with their contents, it is possible to make a display for instructing the user to load a suitable optical disk or exchange the optical disk. Thus, the user can avoid loading an unsuitable optical disk or failure in exchanging the loaded disk with a suitable one. In addition, after the recording reservation is made, if the optical disk is not loaded, a display is made for instructing the user to load a suitable optical disk. Therefore, it is prevented to load an unsuitable optical disk. In addition, after the recording of the previous recording reservation is finished and before the next recording is started, if the type of the next program is different from that of the previous program, a display is made for instructing the user to exchange the loaded disk with a suitable optical disk. Therefore, it is prevented to record on the unsuitable optical disk.

Furthermore, since the program discriminating information of the program to be recorded next is displayed, the user does not need to look up the next program. In addition, if remaining time for which the recording can be performed on the optical disk is shorter than the recording hours of the program, a message for instructing the user to exchange the loaded disk with an unused optical disk is displayed. Therefore, it is prevented that the recording cannot be performed completely due to insufficient capacity of the optical disk. When the optical disk recording and reproducing device having this structure, the user's load of managing the program contents of the recording reservations and the optical disks to be used can be reduced so that usability is improved.

What is claimed is:

1. An optical disk recording and reproducing device for recording and reproducing information on the optical disk, the device equipped with a system controller comprising:
a disk discriminating information storing portion for storing a disk discriminating information table in a memory, for discriminating the optical disk in accordance with a type of a television program when the optical disk is loaded;
a recording reservation information storing portion for storing recording reservation information table in a memory, which was set when the recording reservation was made;
a program disk discriminating information recording portion for assigning program discriminating information and disk identification information to an unused optical disk when it is loaded and for recording the information on the optical disk;
a memory side information obtaining portion for obtaining the program discriminating information of next recording from the recording reservation information table stored in the memory and the disk identification information from the disk discriminating information table stored in the memory when the recording reservation of the television program is made or the recording is finished;
an optical disk side information obtaining portion for obtaining the program discriminating information and the disk identification information recorded on an optical disk when the optical disk is loaded after the program discriminating information and the disk identification information are obtained;
a suitable optical disk load instruction display portion for making the display portion display a message for instructing the user to load a suitable optical disk indicated by the program discriminating information and the disk identification information and for making the display portion display program discriminating information of the next recording if an optical disk is not loaded after the memory side information obtaining portion obtained the program discriminating information and the disk identification information; and
a suitable optical disk exchange instruction display portion for making the display portion display a message for instructing the user to exchange the loaded disk with an optical disk that is suitable for a program discrimination number and the disk identification information of the memory side and for making the display portion display program discriminating information of the next recording if the program discriminating information and the disk identification information obtained by the memory side information obtaining portion do not match with the program discriminating information and the disk identification information obtained by the optical disk side information obtaining portion after the optical disk side information obtaining portion obtained the program discriminating information and the disk identification information.

2. The optical disk recording and reproducing device according to claim 1, wherein the disk discriminating information table includes program discriminating information indicating a title, a genre and a serial number of the same title for discriminating the television program to be recorded on the optical disk, disk identification information for identifying the optical disk and remaining time information indicating remaining time for which the recording can be performed on the optical disk.

3. The optical disk recording and reproducing device according to claim 1, wherein the recording reservation information table includes a channel that was set when the recording reservation was made, a recording date and time, recording hours and program discriminating information.

4. The optical disk recording and reproducing device according to claim 1, wherein the system controller includes an unused optical disk exchange instruction display portion for making the display portion display a message for instructing the user to exchange the loaded disk with an unused optical disk if remaining time for which the recording can be performed on the optical disk is shorter than recording hours of the program although the program discriminating information and the disk identification information obtained by the memory side information obtaining portion match with the program discriminating information and the disk identification information obtained by the optical disk side information obtaining portion.
